(19) United States
(12) Patent Application Publication
(10) Pub. No.: US 2004/0148832 A1
(43) Pub. Date: Aug. 5, 2004

(54) Portable display device

(76) Inventor: Abraham Albenda, Brooklyn, NY (US)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/723,077

(22) Filed: Nov. 26, 2003

Related U.S. Application Data
(60) Provisional application No. 60/445,170, filed on Feb. 5, 2003.

(51) Int. Cl. G09F 15/00

(52) U.S. Cl. 40/610

(57) ABSTRACT

Display device including a unitary, rigid sheet defining a left center panel, a right center panel pivotally connected to the left center panels, a left side panel pivotally connected to the left center panel and a right side panel pivotally connected to the right center panel. Vertically extending separation lines are formed on a rear planar layer without penetrating or cutting a front planar layer so that the panels are able to pivot about vertical axes. Fold lines may be formed opposite the separation lines on the front planar layer to facilitate folding the sheet whereby the fold lines define the vertical axes about which the panels pivot. Folding of the sheet provides a compact configuration which enables the display device to be easily carried.

### CROSS REFERENCE TO RELATED APPLICATION

This application claims priority under 35 U.S.C. § 119(e) of U.S. provisional patent application Ser. No. 60/445,170 filed Feb. 5, 2003.

### FIELD OF THE INVENTION

The present invention relates generally to a portable display and more particularly to a portable display for use in educational fields such as to display educational material, students' classroom work and home work, art projects and projects for science fairs and the like.

Additionally, the present invention relates to a portable display that can be used by teachers in lessons and by other professionals in presentations.

### BACKGROUND OF THE INVENTION

Primary and secondary schools often conduct various science fairs and the like which require students to conduct or investigate an aspect of science and present a report on the same. Typically, students use rigid poster boards to display materials related to their projects. One problem with such rigid poster boards are their inflexibility which results in difficulties in carrying the poster boards.

Therefore, display devices have been developed which are foldable. For example, U.S. Pat. Nos. 4,794,712, 5,293,705 and 5,911,522 describe a portable display device which includes three panels, namely, a center panel and two side panels, one on each side of the center panel. The side panels have a width one-half of the width of the center panel and are hinged to the center panel so that they can be folded against the center panel to thereby reduce the size of the display device in half and make carrying the display device easier. When expanded into the display configuration, the display device has a width equal to twice the width of the center panel. In spite of the reduction in the width of the display device for carrying purposes, the display device still has a rather large width, which is the width of the center panel, and is therefore difficult to carry.

Accordingly, it would be desirable to have a display device which is collapsible into a more compact form which is easy to carry, especially for schoolchildren.

### OBJECTS AND SUMMARY OF THE INVENTION

It is an object of the present invention to provide a new and improved portable display device which is easy to carry.

It is another object of the present invention to provide a new and improved portable display for use in educational fields such as to display educational material, students' classroom work and home work, art projects and projects for science fairs and the like.

It is yet another object of the present invention to provide a new and improved lightweight display device.

It is still another object of the present invention to provide a new and improved display device which is easily collapsed and folded into a compact form.

In order to achieve these objects and others, a display device in accordance with the invention includes a unitary, rigid sheet of plastic or other appropriate material defining a left center panel, a right center panel pivotally coupled to the left center panel, a left side panel pivotally connected to the left center panel and a right side panel pivotally connected to the right center panel. The right and left center panels may be indirectly pivotally coupled to one another via the formation of a spine panel therebetween to which both the left and right center panels are pivotally coupled. To partition the sheet into the panels, vertically extending separation lines are formed in or on a rear planar layer without penetrating or cutting a front planar layer so that the panels are able to pivot about vertical axes.

The sheet may be corrugated or solid. When the sheet is solid, the separation lines would constitute elongate portions having a reduced thickness or living hinges.

Fold lines may be formed opposite the separation lines on the front planar layer to facilitate folding the sheet whereby the fold lines define the vertical axes about which the panels pivot. Folding of the sheet provides a compact configuration which enables the display device to be easily carried. In some embodiments, the fold lines in the front planar layer may be lightly scored or serrated to enable easier pivotal movement of the panels about the fold lines.

The sheet is formed from the front and rear substantially planar layers of plastic or other appropriate materials which are connected by parallel ribs to define cavities. The ribs can extend vertically or horizontally so that the separation lines between the panels can be either perpendicular or parallel to the corrugation of the sheet.

In addition to the vertically extending separation lines, the rear planar layer of the sheet may be provided with one or more horizontally extending separation lines to separate the sheet into vertical sections and enable the vertical sections to pivot about a horizontal axis. This provides the sheet with a second compact configuration.

The corners of the rear and/or front planar layers defined by the upper and lower edges of the planar layers and the separation lines, may be rounded to prevent injury to people caused by the otherwise sharp edges of the planar layers.

### BRIEF DESCRIPTION OF THE DRAWING

The invention, together with further objects and advantages thereof, may best be understood by reference to the following description taken in conjunction with the accompanying drawings, wherein like reference numerals identify like elements and wherein:

FIG. 1A is a front, perspective view of a portable display device in accordance with the invention in an open or display.

FIG. 1B is a rear view of one embodiment of the portable display device shown in FIG. 1A.

FIG. 1C is a rear view of another embodiment of the portable display device shown in FIG. 1A.

FIG. 1D is a rear view of still another embodiment of the portable display device shown in FIG. 1A.

FIG. 2 is a top view of the portable display device shown in FIG. 1D in a compact, carrying configuration.

FIG. 3 is a fragmentary perspective view of one embodiment of a separation line running perpendicular to the corrugation in the display device in accordance with the invention.

FIG. 4 is a fragmentary side view of another embodiment of a separation line running perpendicular to the corrugation in the display device in accordance with the invention.

FIG. 5 is a side view of the portable display device shown in FIG. 1D in a second compact, carrying configuration.

FIG. 6 is a fragmentary side view of a separation line running parallel to the corrugation in the display device in accordance with the invention.

FIG. 7 is a fragmentary side view of another embodiment of a separation line running parallel to the corrugation in the display device in accordance with the invention.

FIG. 8A is a fragmentary rear view of one embodiment of the display device in accordance with the invention.

FIG. 8B is a fragmentary rear view of another embodiment of the display device in accordance with the invention.

FIG. 9 is a rear view of two display devices in accordance with the invention arranged one on top of another.

FIG. 10 is a cross-sectional view taken along the line 10-10 of FIG. 9.

FIG. 11 is a cross-sectional view showing another arrangement of two display devices in accordance with the invention, one on top of another.

FIG. 12 is a fragmentary perspective view of a separation line running perpendicular to the corrugation in another embodiment of the display device in accordance with the invention.

FIG. 13 is a fragmentary side view of a separation line running parallel to the corrugation in another embodiment of the display device in accordance with the invention.

FIG. 14 is a fragmentary side view of another embodiment of a display device in accordance with the invention.

FIG. 15 is a rear view of another embodiment of the portable display device shown in FIG. 1A.

FIG. 16 is a top view of the portable display device shown in FIG. 15 in a compact, carrying configuration.

### DETAILED DESCRIPTION OF THE INVENTION

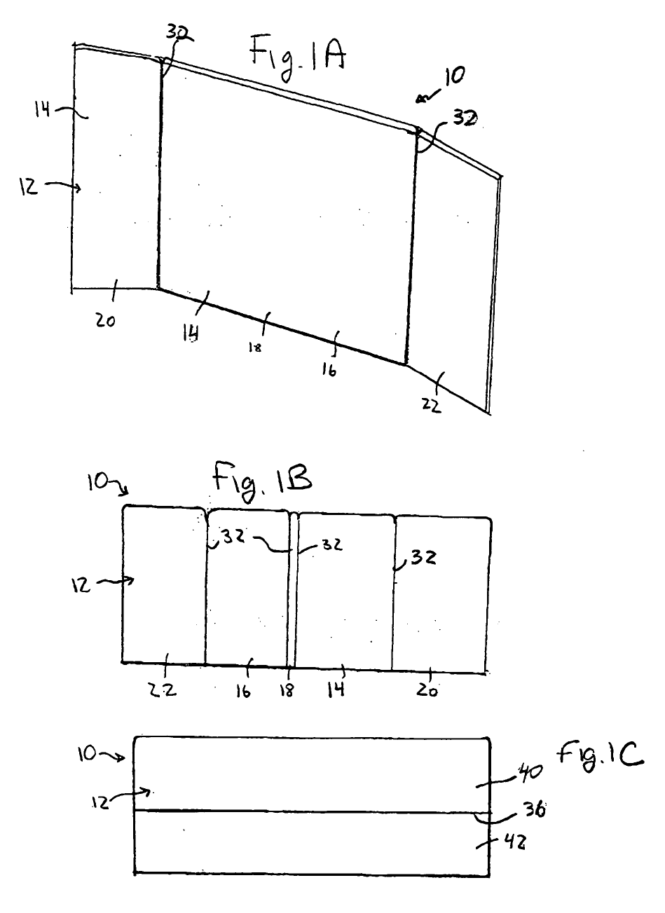

Referring to the accompanying drawings wherein like reference numerals refer to the same or similar elements, FIGS. 1A and 1B show a display device in accordance with the invention which is designated generally as 10 and comprises a single sheet 12 of corrugated plastic or other appropriate material separated into a plurality of connected panels, namely, a left center panel 14, a right center panel 16, a spine panel 18 arranged between the left and right center panels 14,16, a left side panel 20 connected to the left center panel 14 and a right side panel 22 connected to the right center panel 16.

The left center panel 14 is pivotally coupled to the right center panel 16 via the spine panel 18 (i.e., an indirect pivotal coupling) so that the left and right center panels 14, 16 are rotatable relative to one another. As discussed below with reference to FIGS. 15 and 16, the spine panel 18 may be eliminated with the result that the left center panel 14 is directly pivotally connected to the right center panel 16.

The separation of the sheet 12 into the different panels is designed to enable the sheet 12 to be easily folded between the open or display configuration shown in FIG. 1A and the closed or compact configuration shown in FIG. 2, e.g., for carrying and transportation purposes. The folding may be either an inward folding wherein the lateral edges of the sheet 12 are brought inward to be situated between other parts of the sheet 12, described with reference to FIG. 2, or an outward folding wherein the lateral edges are not brought between other parts of the sheet 12, described below with reference to FIGS. 15 and 16. The outward folding allows for various sized panels substantially without dimensional limitations.

As to the inward folding, the widths of the panels 14, 16, 18, 20, 22 must be dimensioned to allow the side panels 20,22 to fold into a space between the right and left center panels 14,16. Left side panel 20 thus has a shorter width than the width of the left center panel 14 as it will be folded up against the left center panel 14 when in the compact configuration, i.e., a planar surface of the left side panel 20 will face a planar surface of the left center panel 14. Similarly, the right side panel 22 has a shorter width than the width of the right center panel 16 as it will be folded up against the right center panel 16 when in the compact configuration, i.e., a planar surface of the right side panel 22 will face a planar surface of the right center panel 16. The left and right center panels 14, 16 preferably have the same width. The width of the spine panel 18 is selected to enable the formation of sufficient separation between the left and right center panels 14,16 when in the compact configuration to accommodate the thickness of the left and right side panels 20,22.

In the display configuration shown in FIG. 1A, the panels 14, 16, 18, 20, 22 may be positioned to provide the sheet 12 with a flat configuration so that display materials can be affixed to a front, planar surface of the sheet 12 over any number of the panels. The sheet 12 could also be attached to a wall or leaned against blackboard. The display device 10 might also include a support mechanism attached to the rear surface to enable the display device 10 to be reliably self-standing.

It is also possible to fold or bend one or both of the side panels 20, 22 relative to the remaining panels in the display device 10 to thereby provide the display device 10 with either an L-shaped display or a C-shaped display. This might be useful for some projects or if the space allotted for a project is limited.

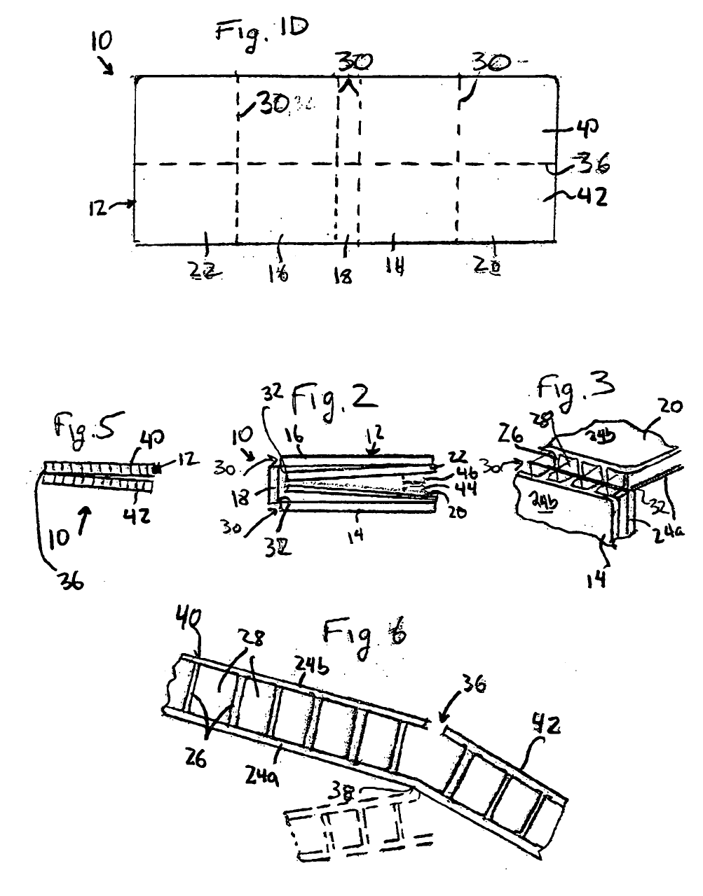

As shown in FIG. 3, the sheet 12 is formed from opposed substantially planar layers of plastic or other appropriate material 24a, 24b connected by ribs 26 to thereby define cavities 28. The planar layers 24a, 24b may be substantially coextensive with one another, although portions of one or both planar layers 24a, 24b may be removed as discussed below.

To form the panels 14, 16, 18, 20, 22, vertically extending separation lines 30 are formed in the planar layer 24a on the rear side of the sheet 12, one separation line 30 will be present between each adjacent pair of panels (see FIG. 1B). The separation lines 30 extend from the bottom of the sheet 12 to the top of the sheet 12 to thereby partition the sheet 12 into the panels or horizontal sections. As used herein, a “horizontal section” is a part of the sheet 12 which extends between the upper and lower edges of the sheet 12 over only a portion of the width of the sheet 12. Each horizontal section or panel 14, 16, 18, 20, 22 extends from the bottom of the sheet 12 to the top of the sheet 12 to enable the sheet 12 to bend uniformly over its entire height.

The sheet 12 may be formed with the ribs 26 in either a vertical orientation, i.e., extending vertically from a lower edge of the sheet 12 to an upper edge of the sheet 12, or in a horizontal orientation, i.e., extending horizontally from a left edge of the sheet 12 to the right edge of the sheet 12. FIGS. 3-7, 9 and 10 are taken when the ribs 26 are in a horizontal orientation (the separation lines 30 are thus perpendicular to the corrugation) whereas FIG. 11 is taken when the ribs 26 are in a vertical orientation (the separation lines 30 being parallel to the corrugation).

Thus, as shown in FIG. 3, the separation lines 30 are constituted by a cut through the rear planar layer 24a and ribs 26. However, if the ribs 26 were in a vertical orientation, then the separation lines between panels 14, 16, 18, 20, 22 would be cuts in the rear planar layer 24a between a pair of adjacent ribs 26 (such as shown in FIG. 6). The separation lines 30 thus can be formed either parallel to the corrugation (between adjacent pairs of ribs 26) or perpendicular to the corrugation (through the ribs 26).

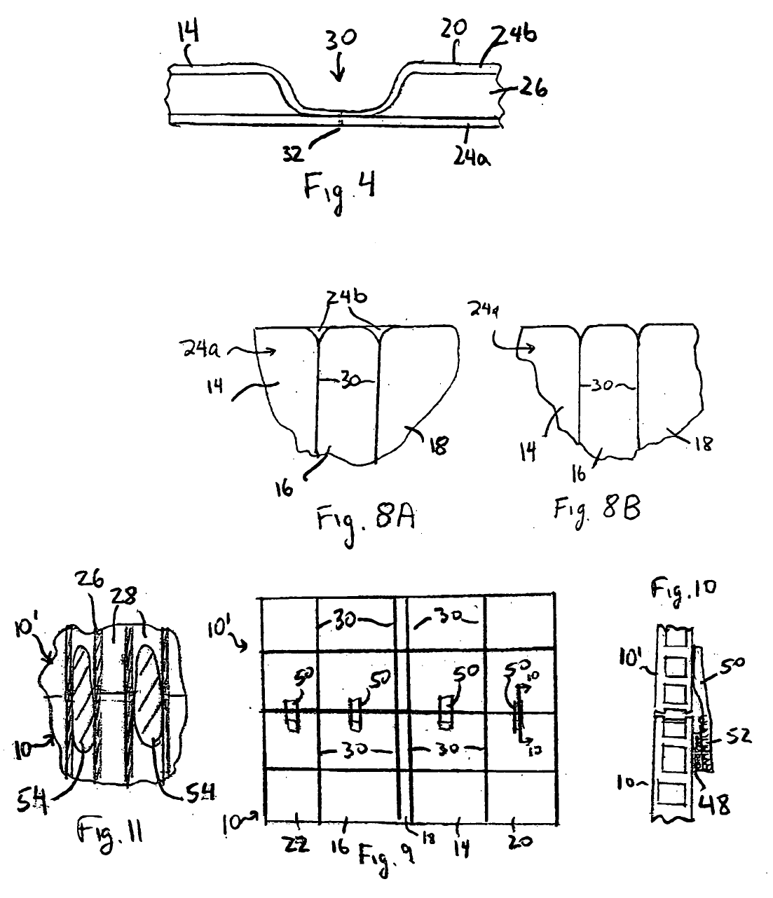

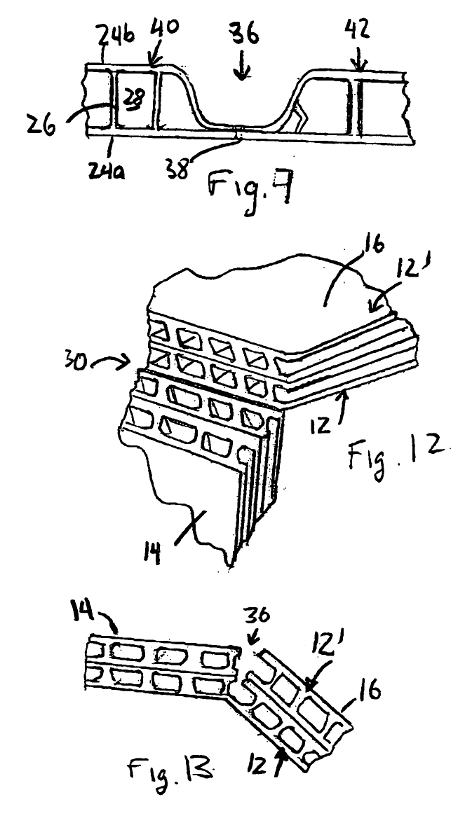

Instead of cutting the rear planar layer 24a, another way to form the separation lines 30 is to crush a portion of the sheet 12, i.e., press the rear planar layer 24a against the planar layer 24b on the front side of the sheet 12 with the result that the portion of the ribs 26 therebetween are crushed, and then heating the crushed portion to cause the rear planar layer 24a and crushed ribs 26 to melt onto the front planar layer 24b (see FIG. 4).

By forming the separation lines 30 in conjunction with only the rear planar layer 24a, the panels 14, 16, 18, 20, 22 remain attached to one another via the front planar layer 24b. Fold or hinge lines 32 are thus formed in the front planar layer 24b opposite the separation lines 30 in the rear planar layer 24a (see FIGS. 3 and 4). To improve the flexibility of the panels about the fold lines 32, the fold lines 32 may be scored, which is particularly preferable when the separation lines 30 are formed by the crushing technique. This enables the panels 14, 16, 18, 20, 22 to pivot forward around the fold lines 32 to thereby enable the compact configuration shown in FIG. 2 to be obtained.

The presence of the separation lines 30 formed in connection with the rear planar layer 24a and the fold lines 32 in the front planar layer 24b provides for easy changes in the configuration of the sheet 12 between the display configuration shown in FIG. 1 and the compact configuration shown in FIG. 2. To change from the display configuration to the compact configuration, the left side panel 20 is pivoted inward about the fold line 32 between it and the left center panel 14 while the right side panel 22 is pivoted inward about the fold line 32 between it and the right center panel 16. Then, with the left side panel 20 against the left center panel 14, the left center panel 14 is pivoted inward about the fold line 32 between it and the spine panel 18. With the right side panel 22 against the right center panel 16, the right center panel 16 is pivoted inward about the fold line 32 between it and the spine panel 18. The configuration shown in FIG. 2 is thereby obtained. To change from the compact configuration to the display configuration, the reverse movements are performed.

In the embodiment illustrated in FIG. 1B, the sheet 12 is partitioned into five panels 14, 16, 18, 20, 22. Nevertheless, it is conceivable that the sheet 12 may be partitioned into a different number of panels by forming the separation lines 30 and fold lines 32 in the rear and front planar layers 24a, 24b, respectively, at predetermined locations to arrive at the desired number and size of panels. The locations would be selected to enable folding of the sheet 12 about the fold lines 32 into a compact configuration.

Instead of or in addition to the vertically extending separation lines 30, the rear planar layer 24a of the sheet 12 may be provided with one or more horizontally extending separation lines 36 to enable it to be bent about a horizontal axis (see FIGS. 1C, 1D and 6). FIG. 1C shows the presence of a single horizontally extending separation line 36 without the vertically extending separation lines 30 whereas FIG. 1D shows the combination of both horizontally and vertically extending separation lines 30,36.

The separation lines 36, one of which is shown in FIGS. 1C ad 1D, would extend entirely from the left edge of the sheet 12 to the right edge of the sheet 12 and may be constituted by a crimped bend or a cut in the rear planar layer 24a between pairs of adjacent ribs 26 (when the ribs 26 are oriented horizontally). In the alternative, the separation lines 36 may be formed by crushing a portion of the sheet 12, i.e., pressing the rear planar layer 24a against the front planar layer 24b with the result that any ribs 26 therebetween are crushed, and then heating the crushed portion to cause the rear planar layer 24a and crushed ribs 26 to melt onto the front planar layer 24b (see FIG. 7).

Horizontally extending fold lines 38 are formed in the front planar layer 24b opposite the separation lines 36 in the rear planar layer 24a. Fold lines 38 may constitute a series of serrations formed in the front planar layer 24b or be scored to facilitate folding of the sheet 12 about fold line 28.

The horizontally extending separation lines 36 and fold lines 38 enable the sheet 12 to be folded or bent to provide an alternative compact configuration, such as shown in FIG. 5. In this configuration, the sheet 12 is bent about the fold line 38, which would be formed in the middle of the sheet 12, heightwise, so that an upper vertical section 40 of the sheet 12 is folded against a lower vertical section 42 of the sheet 12 (see FIG. 6 wherein the folded position is shown in dotted lines). As used herein, a “vertical section” is a part of the sheet 12 which extends between the left and right edges of the sheet 12 over only a portion of the height of the sheet 12. Each vertical section 40,42 extends from the left edge of the sheet 12 to the right edge of the sheet 12 to enable the sheet 12 to bend uniformly over its entire length. In view of the presence of separation lines 30 discussed above, the separation lines 36 may be discontinuous at the separation lines 30 and vice versa.

The separation lines 36 and opposed fold lines 38 can be arranged in any pattern, spacing and number to provide any desired degree of flexibility, although if multiple separation lines 36 and fold lines 38 are provided, they should be substantially parallel to one another.

The sheet 12 could thus be folded from the display configuration shown in FIG. 1A into either the compact configuration shown in FIG. 2 or the compact configuration shown in FIG. 5. Depending on the size of the sheet 12 and the position of the separation lines 30, 36 and opposed fold lines 32, 38, the configuration shown in FIG. 5 may be longer and narrower than the configuration shown in FIG. 2 so that it might be easier for a child to hold when in the position shown in FIG. 5.

The sheet 12 may be formed from one or more sturdy materials known to those skilled in the art including but not limited to plastic, cardboard, foam or treated paper. One suitable plastic is polypropylene. The sheet 12 can be formed to be entirely clear, transparent or translucent, or with a combination of clear, transparent and/or translucent portions. The front planar layer 24b may also be colored in various colors. Optionally, the front planar surface layer 24b may be formed from an erasable and washable material, which would enable its use as a writing board.

Several optional features may be incorporated into the sheet 12 to enhance and improve its use. One such feature is to round the corners of the rear planar layer 24a, the corners being defined by the upper and lower edges of the rear planar layer 24a and the separation lines 30 (see FIGS. 3, 8A and 8B). By rounding the corners, sharp edges are removed which prevents injury during handling of the display device 10. It is possible to round all (or possibly only some) of the edges of only the rear planar layer 24a (as shown in FIG. 8A wherein the front planar layer 24b is viewed through behind the rounded corners) or in the alternative, all of the corners of both the rear and front planar layers 24a, 24b (as shown in FIG. 8B).

Another feature would be to incorporate a flame retardant into the sheet 12 to prevent burning of the display device 10.

The display device 10 may be provided with several optional features to enhance its use. One feature is an attachment mechanism to maintain the display device 10 in the compact configuration shown in FIGS. 2 and 5. One such attachment mechanism is shown in dotted lines in FIG. 2 and comprises a strip 44 of hook-type fasteners arranged on the outer surface of the rear planar layer 24a of the left side panel 20 and a strip 46 of loop-type fasteners arranged on the outer surface of the rear planar layer 24a of the right side panel 22. During closing of the display device, the left and right side panels 20, 22 can be brought close to one another to cause engagement of the strips 44,46 and thus attachment of the left and right side panels 20,22 together. This would maintain the display device 10 in the compact configuration shown in FIG. 2.

Another feature which may be included in the display device is an attachment mechanism for attaching multiple display devices 10 together, e.g., when a tall poster board is needed. This attachment mechanism may comprise a strip 48 of hook or loop-type fasteners arranged on the outer surface of the rear planar layer 24a of the side and center panels 14, 16, 20, 22 on one display device 10 and a strap 50 having an area 52 of the other of the hook or loop-type fasteners arranged on the outer surface of the rear planar layer 24a of the side and center panels 14, 16, 20, 22 of another display device 10′ (see FIGS. 9 and 10). To attach the display devices 10,10′ together, the straps 50 are placed over the strips 48 to engage the hook and loop-type fasteners together (see FIG. 10).

Another attachment mechanism for attaching display devices 10,10' together, when the ribs 26 thereof are in a vertical orientation, may comprise pegs 54 insertable into the cavities 28 between the ribs 26 (see FIG. 11). The pegs 54 are only partially inserted into cavities in the lower display device 10 and then the upper display device 10′ is positioned such that the pegs 54 align with cavities 28 and the display devices 10,10′ are then pressed together with the pegs 54 partially in each display device 10, 10′. The pegs 54 are spaced along the adjoining surfaces of the display devices 10,10′, preferably so that one peg 54 is present in each of the side and center panels 14, 16, 20, 22. Pegs 54 may be made from wood or plastic or the like and are dimensioned to snugly fit in the cavities 28.

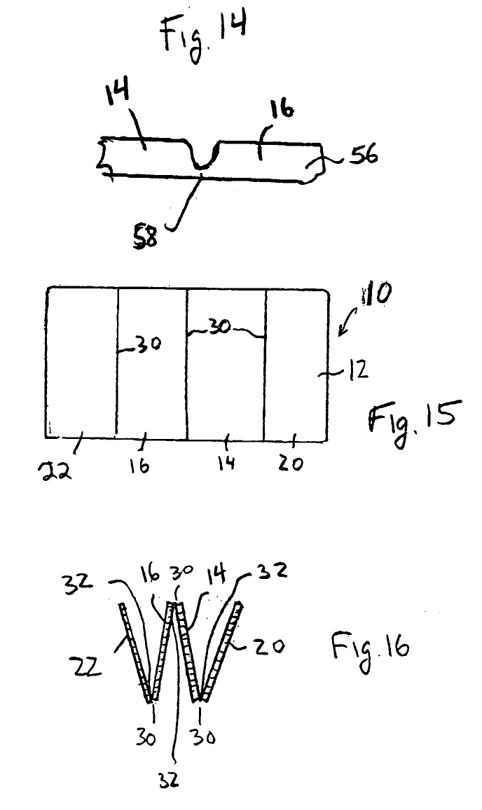

Referring now to FIGS. 12 and 13, the display device 10 may comprise two sheets 12,12′ of corrugated plastic bonded to one another or formed integral with one another. FIG. 12 shows a separation line 30 between two panels 14, 16 when the ribs 26 are in a horizontal orientation, which would also be a separation line between two vertical sections when the ribs 26 are in a vertical orientation. FIG. 13 shows a separation line 38 between two panels 14,16 when the ribs 26 are in a vertical orientation, which would also be a separation line between two vertical sections when the ribs 26 are in a horizontal orientation.

Instead of forming the display device 10 from a corrugated sheet 12, it is also possible to form the sheet 56 from a solid material (such as plastic or any of the other materials mentioned above) with living hinges formed in the rear. As shown in FIG. 14, the panels 14, 16 are separated by a living hinge 58 which constitutes a (vertical or horizontal) elongate portion of the sheet 56 with a reduced thickness.

Referring now to FIGS. 15 and 16, FIG. 15 shows an alternative rear view of the display device 10 shown in FIG. 1A. In this embodiment, the sheet 12 includes only vertically extending separation lines 30, and specifically only three such separation lines 30. One separation line 30 is arranged on the front planar layer 24b situated at the approximate middle of the sheet 12 with the other two being arranged on the rear planar layer 24a and situated at the approximate middle of the thusformed halves of the sheet 12. Thus, there is no spine panel in this embodiment and the left center panel 14 is directly pivotally connected to the right center panel 16.

The display device shown in FIG. 15 is foldable into the W-shaped configuration shown in FIG. 16 wherein the panels 14, 16, 20, 22 fold about the fold lines 32 formed opposite the separation lines 30.

In view of the disclosure of the different embodiments above, it can be seen that the left and right center panels 14, 16 can be separated either by a single separation/fold line 30,32 (FIG. 15) or by two separation/fold lines 30,32 (FIG. 1D). It is also possible to provide more than two separation/fold lines 30,32 between the left and right center panels 30,32.

Accordingly, the number of separation/fold lines 30,32 in the sheet 12 may be three (FIG. 15), or four (FIG. 1D) or more than four. If more than four vertically extending separation/fold lines 30,32 are provided, the sheet 12 can be folded like an accordion into different shapes.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I Claim:

1. A display device, comprising:
a unitary, rigid sheet comprising a left center panel, a right center panel directly or indirectly pivotally coupled to said left center panel, a left side panel pivotally connected to said left center panel and a right side panel pivotally connected to said right center panel.

2. The display device of claim 1, wherein said sheet has a rear planar layer and an opposed front planar layer, said rear planar layer having a plurality of spaced-apart, parallel, vertically extending separation lines to separate said panels from one another along said rear planar layer and enable said panels to pivot about vertical axes.

3. The display device of claim 2, wherein said separation lines extending vertically from a lower edge of said sheet to an upper edge of sheet.

4. The display device of claim 3, wherein corners of said rear planar layer defined by said upper and lower edges and said separation lines are rounded.

5. The display device of claim 2, wherein said separation lines constitutes cuts in said rear planar layer.

6. The display device of claim 2, wherein said separation lines constitutes a crushed, elongate portion of said rear planar layer which is melted onto said front planar layer.

7. The display device of claim 2, wherein said front planar layer includes fold lines formed opposite said separation lines, said fold lines defining the vertical axes about which said panels pivot.

8. The display device of claim 7, wherein said fold lines are scored.

9. The display device of claim 1, wherein said left side panel has a smaller width than said left center panel and said right side panel has a smaller width than said right center panel.

10. The display device of claim 1, wherein said sheet is formed from opposed substantially planar layers of material connected by parallel ribs to define cavities.

11. The display device of claim 10, wherein said ribs extend vertically.

12. The display device of claim 10, wherein said ribs extend horizontally.

13. The display device of claim 1, wherein said sheet has a rear planar layer and an opposed front planar layer, said rear planar layer having at least one horizontally extending separation line to separate said sheet into vertical sections and enable said vertical section to pivot about a horizontal axis.

14. The display device of claim 1, further comprising attachment means for maintaining said sheet in a folded, compact configuration with planar surfaces of said panels facing one another.

15. The display device of claim 14, wherein said attachment means comprise one of hook and loop-type fasteners arranged on a planar surface of said left side panel and the other of hook and loop-type fasteners arranged on a planar surface of said right side panel facing said planar surface of said left side panel with said sheet is in the folded, compact configuration.

16. The display device of claim 1, further comprising attachment means for enabling said sheet to be attached to another similar sheet.

17. The display device of claim 16, wherein said attachment means comprise one of hook and loop-type fasteners arranged on at least one of said panels.

18. The display device of claim 16, wherein said attachment means comprise pegs insertable into cavities formed in upper and lower edges of at least one of said panels.

19. The display device of claim 1, further comprising an additional unitary, rigid sheet substantially coextensive with said sheet.

20. The display device of claim 1, wherein said sheet is corrugated.

21. The display device of claim 1, wherein said sheet is solid.

22. The display device of claim 1, further comprising a spine panel arranged between and pivotally connected to both said left and right center panels.

23. The display device of claim 1, wherein said sheet has a rear planar layer and an opposed front planar layer, said rear planar layer having at least one vertically extending separation line and said front planar layer including at least one fold line opposite to a respective one of said at least one separation line.

24. The display device of claim 1, wherein said sheet has a rear planar layer and an opposed front planar layer, said rear planar layer having a plurality of parallel, spaced-apart vertically extending separation line and said front planar layer including fold lines each opposite a respective one of said separation lines.

25. The display device of claim 24, wherein said separation lines and said fold lines are formed to enable said sheet to fold into a W-shaped configuration.

26. The display device of claim 1, wherein said right center panel is indirectly pivotally coupled to said left center panel via a spine panel.
